(19) United States
(12) Patent Application Publication
(10) Pub. No.: US 2015/0220132 A1
(43) Pub. Date: Aug. 6, 2015

(54) POWER/ENERGY MANAGEMENT APPARATUS BASED ON TIME INFORMATION OF POLICY ENFORCEMENT AND METHOD THEREOF

(71) Applicant: Electronics and Telecommunications Research Institute, Daejeon (KR)

(72) Inventors: Baik Song AN, Seoul (KR); Sung Ik JUN, Daejeon (KR); Jin Ho ON, Daejeon (KR)

(73) Assignee: Electronics and Telecommunications Research Institute, Daejeon (KR)

(21) Appl. No.: 14/613,901

(22) Filed: Feb. 4, 2015

(30) Foreign Application Priority Data
Feb. 5, 2014 (KR) 10-2014-0013139

(51) Int. Cl. G06F 1/32

(52) U.S. Cl. CPC G06F 1/3206; G06F 1/3296

(57) ABSTRACT

Disclosed are an apparatus for managing power/energy based on time information of policy enforcement including a time information acquiring unit configured to acquire management time information including a start time value, an end time value, a day repetition value, and a date repetition value of a power/energy management action with respect to a management target device desired to manage in power/energy, a time information analysis unit configured to analyze the management time information acquired by the time information acquiring unit and to register a management action event for power/energy management in a timer module, and a power management unit configured to perform an power/energy management action on the management target device by checking occurrence of the management action event and controlling operations of control modules of the management target device, and a method thereof.

### CROSS-REFERENCE TO RELATED APPLICATION

This application claims priority to and the benefit of Korean Patent Application No. 10-2014-0013139, filed on Feb. 5, 2014, the disclosure of which is incorporated herein by reference in its entirety.

### BACKGROUND

1. Field of the Invention

The present invention relates to a power/energy management apparatus, and more particularly, to technology for managing power/energy based on time information of policy enforcement.

2. Discussion of Related Art

Today, there is an increasing need of technology for saving energy consumption in IT devices. Dynamic Voltage Frequency Scaling (DVFS), one of the energy saving technologies, is provided to dynamically adjust a clock frequency and a voltage that are led in a system module, and when a system load is increased, the DVFS allows a high clock and voltage, and in other cases, allows a low clock and voltage, thereby saving the power consumption.

For example, a CPU, which has adopted the DVFS on the first, has an operating system level support as well as a hardware level support that has been long achieved. However, the operating system level support is still insufficient, and needs to be further improved.

The conventional energy saving technology is achieved in a way that dynamic power/energy consumed to operate a system is controlled by DVFS. However, there is a need of an efficient power management and control function even in an idle state where a system has no load. The CPU uses a C-state management defined on Advanced Configuration and Power Interface (ACPI), thereby reducing the power consumed on the CPU in a standby mode of the system. In general, C-states are defined for each CPU, and divided by several stages. However, a higher stage enables remarkable reduction of a standby power consumption, but has a great transition overhead of active/idle states, and thus an efficient state management mechanism is needed.

In an idle state of a system, the idle power management function in the whole system level rather than each component level, such as a CPU, is provided through a power saving and maximum power saving function. In general, if a system maintains an idle state for a predetermined period of time or longer, status information of the system is stored in a storage or disk, and the electricity of the whole system is shut down, to reduce the power load. In this case of storing status information in a storage (a power saving function, suspend-to-RAM), a recovery time is relatively short, while the power of the storage cannot be shut down and thus the power saving effect is lowered. In addition, at the time of storing status information in a disk (a maximum power saving function, suspend-to-disk), there is no loss of information even if the disk, which is non-volatile, has a power failure, thereby ensuring a power saving effect corresponding to a system power off. However, at the time of recovery, data needs to be read from the disk, and the recovery takes a great amount of time.

The conventional power/energy saving technology has a configuration shown in FIG. 1 that is implemented and applied at an operating system kernel level. For example, the conventional power/energy saving technology operates by including separate modules implemented and operated for respective power management functions, and largely divided into three modules.

A dynamic voltage/clock control module is a module configured to save power/energy consumed when a system is dynamically operated. The dynamic voltage/clock control module controls system components to which various voltages and clock frequencies are allowed (mainly, a CPU), but in the future, the application range will be expanded, for example, even to a storage. An idle state control module performs power consumption saving at a component level in a system idle state. A power saving/maximum power saving control module serves to more effectively induce power saving through a power saving/maximum power saving function at a system level rather than a component level.

As shown in FIG. 1, power management control modules (a dynamic voltage/clock control module 10, an idle state control module 20, and a power saving/maximum power saving control module 30) configured to perform a power management function on a computing device (an IT device) are each provided with a plurality of device managers 11, 12, 21, 22, 31, and 32 as lower level parts corresponding to respective hardware related to the control modules 10, 20, and 30, to monitor and control the hardware. In addition, each of the control modules 10, 20, and 30 requires a user setting input as an upper level part such that a user setting is enabled.

In general, a user level setting is provided through a /sys file system interface, and in this case, a user needs to individually perform setting for each power management function, which causes inconvenience in the system power management, and lowers the user's efficiency.

Such a large number of power/energy management functions exist, but at the time of needing power/energy management of a computing device, there is a constraint that the power/energy of the IT device is adaptively managed based on a request from a user each time of the need, depending on how the power/energy function is processed or what load condition the system has. In addition, despite that the above-described power management functions are required to be all considered for the system power management, setting and management need to be separately performed, so that there is an increasing demand for a more collective and efficient power management system.

That is, the conventional power/energy management technology has the following drawbacks.

An IT device used in an office (for example, a computer), which has a power saving function, is frequently used in an inactive state, and there is no method of preventing a user from leaving a computer turned on without noticing and doing anything, which causes waste of power.

In addition, the conventional power control method requests a power saving/maximum power saving mode to start if a system idle state continues for a predetermined period of time or longer. Accordingly, in order to check elapse of the predetermined period of time, the IT device needs to be continuously monitored.

In addition, a method of setting a power saving mode is different for each IT device and each function, which is inefficient in the user convenience and the operation efficiency.

### SUMMARY OF THE INVENTION

The present invention is directed to a technology for collectively managing various power control functions based on time information.

According to an aspect of the present invention, there is provided an apparatus for managing power/energy based on time information of policy enforcement, the apparatus including a time information acquiring unit, a time information analysis unit, and a power management unit. The time information acquiring unit may be configured to acquire management time information including a start time value, an end time value, a day repetition value, and a date repetition value of a power/energy management action with respect to a management target device desired to manage in power/energy. The time information analysis unit may be configured to analyze the management time information acquired by the time information acquiring unit and to register a management action event for power/energy management in a timer module. The power management unit may be configured to perform a power/energy management action on the management target device by checking occurrence of the management action event and controlling operations of control modules of the management target device.

According to another aspect of the present invention, there is provided a method of managing power/energy based on time information of policy enforcement, the method including: acquiring management time information including at least one of a start time value, an end time value, a day repetition value, a date repetition value, and a priority value of a power/energy management action with respect to a management target device; extracting information about a time at which a power/energy management action event with respect to the management target device occurs, by analyzing the management time information; registering a management action event including a start event and an end event of the power/energy management action by using the extracted time information; and performing a power/energy management action on the management target device by checking occurrence of the management action event.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a diagram illustrating a functional structure of the conventional power/energy management technology of an operating system level;

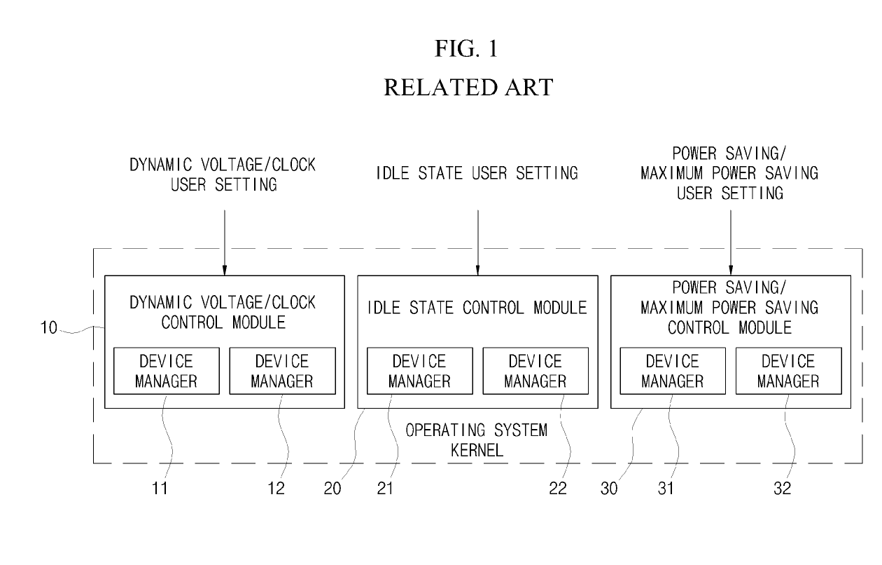

FIG. 2 is a diagram illustrating a system structure of a general IT device on which a power/energy management apparatus according to an exemplary embodiment of the present invention is loaded;

FIG. 3 is a diagram illustrating a configuration of the whole system including a power/energy management apparatus based on time information according to an exemplary embodiment of the present invention;

FIG. 4 is a block diagram illustrating a power/energy management apparatus based on time information according to an exemplary embodiment of the present invention;

FIG. 5 is a flowchart showing a power/energy management method performed by a power/energy management apparatus according to an exemplary embodiment of the present invention;

FIG. 6 is a first flowchart showing a detailed operation of a power/energy management apparatus according to an exemplary embodiment of the present invention;

FIG. 7 is a second flowchart showing a detailed operation of a power/energy management apparatus according to an exemplary embodiment of the present invention; and

FIG. 8 is a diagram illustrating an application example of a power/energy management apparatus according to an exemplary embodiment of the present invention.

FIG. 9 is a block diagram illustrating a computer system for the present invention.

### DETAILED DESCRIPTION OF EXEMPLARY EMBODIMENTS

The above and other advantages, and a scheme for achieving the advantages of the present invention will become readily apparent by reference to the following detailed description when considered in conjunction with the accompanying drawings. However, the scope of the present invention is not limited to such embodiments and the present invention may be realized in various forms. The embodiments to be described below are nothing but the ones provided to bring the disclosure of the present invention to perfection and assist those skilled in the art to completely understand the present invention. The present invention is defined only by the scope of the appended claims. Meanwhile, the terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Hereinafter, exemplary embodiments of the present invention will be described in detail below with reference to the accompanying drawings. The same reference numerals are used to designate the same elements throughout the drawings. Descriptions of well-known functions and structures are omitted to enhance clarity and conciseness.

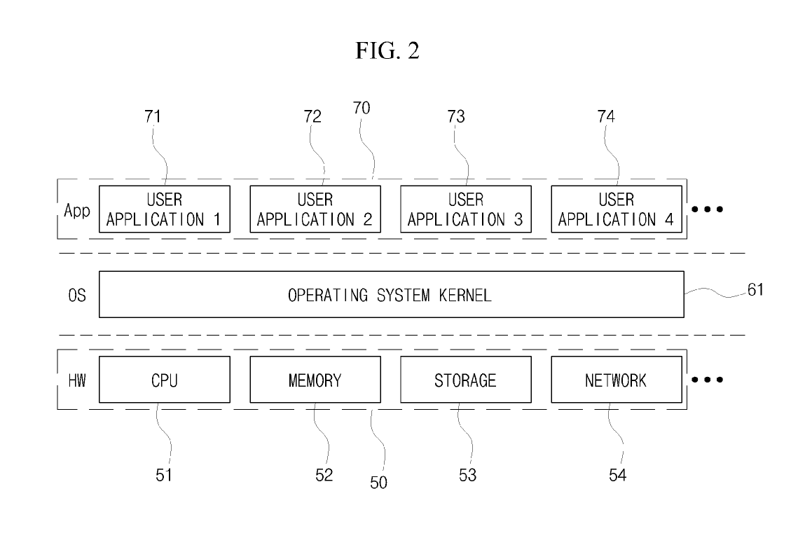

FIG. 2 is a diagram illustrating a system structure of a general IT device (a management target device) including an operating system kernel and on which a power/energy management apparatus according to an exemplary embodiment of the present invention is loaded. Referring to FIG. 2, an IT device including a CPU 51, a memory 52, a storage system 53, and a network system 54 is provided with an operating system kernel OS 61 at an upper level of hardware HW 50 of the IT device. The operating system kernel OS 61 manages resources of a system including the hardware HW 50, and provides services to a user application App 70 including a plurality of user applications 71 to 74 provided at an upper level of the operating system kernel OS 61. The user application App 70 is a concept including a system level library and middleware, and defines and implements a series of functions to provide a user with a direct service. In addition, the user application App 70 communicates with the operating system kernel OS 61 provided at a lower level of the user application App 70 through a system call and a predefined system interface.

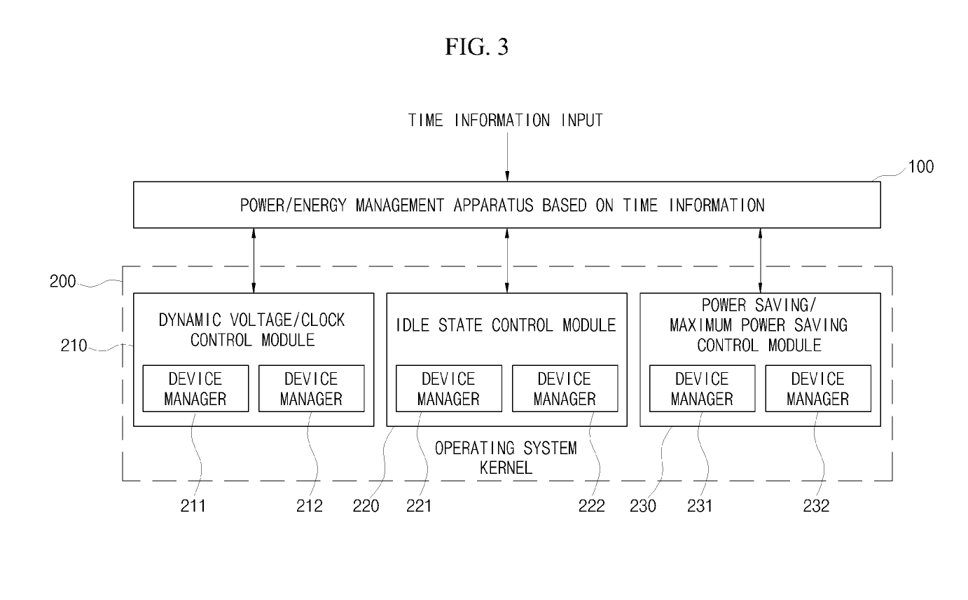

FIG. 3 is a diagram illustrating a configuration of the whole system including a power/energy management apparatus based on time information according to an exemplary embodiment of the present invention. Referring to FIG. 3, the power/energy management apparatus based on time information 100 is provided at an upper level of control modules (a dynamic voltage/clock control module 210, an idle state control module 220, and a power saving/maximum power saving control module 230) for power management/saving of the inside of an operating system kernel 200 of a management target device (hereinafter, referred to as an ‘IT device’) desired to manage in power/energy, and the power/energy management apparatus 100 serves to perform communication with and control on the respective control modules 210, 220, and 230. The control modules 210, 220, and 230 control the operation of the IT device by controlling a plurality of device managers 211, 212, 221, 222, 231, and 232 included in the respective one of the control modules 210, 220, and 230.

In addition, the power/energy management apparatus 100 properly calls and controls the control modules 210, 220, and 230 by analyzing and arranging time information received from a user. The control modules 210, 220, and 230 of respective functions may be subject to user setting through an additional interface as in the conventional scheme. However, if the user setting of the control modules 210, 220, and 230 for respective functions conflicts with the setting of the power/energy management apparatus 100, the control modules 210, 220, and 230 operate based on a priority order defined at a system management level.

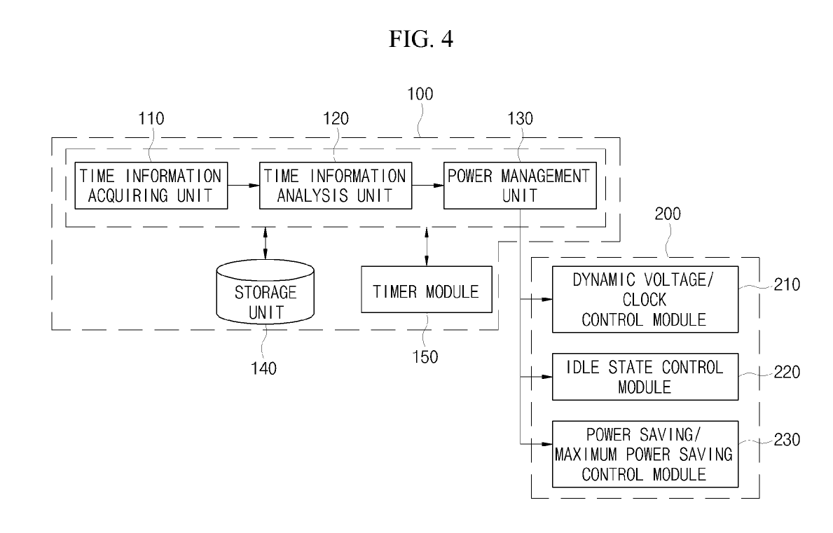

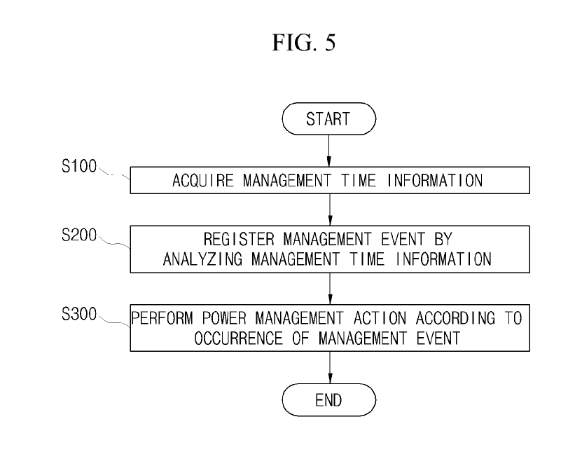

For this, the power/energy management apparatus based on time information 100 according to an exemplary embodiment of the present invention includes a time information acquiring unit 110, a time information analysis unit 120, a power management unit 130, and a storage unit 140 as shown in FIG. 4. Hereinafter, the configuration and operation of the power/energy management apparatus 100 will be described in detail with reference to FIGS. 4 to 7. FIG. 5 is a flowchart showing a power/energy management method performed by the power/energy management apparatus 100 according to an exemplary embodiment of the present invention.

In step S100, the time information acquiring unit 110 of the power/energy management apparatus 100 acquires management time information.

The time information acquiring unit 110 may acquire management time information through a user interface for user input, and in this case, acquire the user input through a key button or a touch panel. For example, if a management target device (an IT device) desired to control in terms of power/energy is a personal computer (PC), the time information acquiring unit 110 may acquire management time information entered by a user through a user interface, such as a keyboard and a mouse.

In this case, the time information acquiring unit 110 acquires management time information for power/energy management of the IT device. For example, the time information acquiring unit 110 acquires through a user interface, management time information including a start time value, an end time value, a day repetition value, and a date repetition value and provided in the form of a rule. The start time value and the end time value are used to start and end a power saving mode (or a maximum power saving mode) action of an IT device for power/energy management. The day repetition value and the date repetition value are used to repeatedly perform a maximum power saving mode action of an IT device for power/energy management on a certain day or certain date of each month.

In addition, the time information acquiring unit 110 may further acquire a priority value of the acquired management time information. In this manner, a rule to be primarily applied among a plurality of rules (a plurality of pieces of management time information) is determined when a time interval between a start and an end of one rule overlaps a time interval between a start and an end of another rule.

The management time information acquired through the time information acquiring unit 110 is stored in the storage unit 140. The storage unit 140 can be accessed by a user, and the management time information stored in the storage unit 140 may be deleted or corrected by the user.

For example, management time information acquired by the time information acquiring unit 110 may be stored in the storage unit 140 in the form of Table 1 below.

TABLE 1

| Priority | Start time | End time | Day repetition | Date repetition |
|---|---|---|---|---|
| 1 | 19:30 | 23:59 | Mon.-Fri. | N/A(not applicable) |
| 2 | 09:00 | 18:00 | N/A | 18, 19, 20 |
| . . . | . . . | . . . | . . . | . . . |

In addition, the storage unit 140 may store default management time information. The default management time information represents rule information that is to be applied to a time interval for which no rule is defined in the management time information. The default management time information also may be input by a user through a user interface, and stored/corrected. The default management, by nature, need not have start/end time information and repetitive application information, and only defines an action for each required function. For example, the default management time information stored in the storage unit 140 may be provided in the form of Table 2 below.

TABLE 2

| | | | Power | |
|---|---|---|---|---|
| | | | saving/ | |
| | | | Maximum | |
| | DVFS | Idle state | power saving | |
| Type | control | control | control | Preset |
| 1 | On-demand | System setting | 10 min/30 min | N/A(not applicable) |
| 2 | N/A | N/A | N/A | 2 |

For example, the default management time information stored in the storage unit 140 may be one of Type 1 and Type 2 shown in the Table 2. Alternatively, another type may be included by a user input setting.

Type 1 separately defines an action for each function of an IT device desired to manage in power/energy. For example, if an action for each function is ‘system setting’, the function is performed according a system basic setting value (for example, a factory default setting value).

In addition, Type 2 indicates a plurality of IDs of Preset that are previously set in consideration of complicacy in setting an action for each function. Each of the IDs of Preset is previously assigned a value to control Dynamic Voltage Frequency Scaling (DVFS), an idle state, and a power saving/maximum power saving.

In addition, the time information acquiring unit 110 may acquire management time information by use of a pattern of a load of the IT device analyzed through an additional load pattern analyzer. The load pattern analyzer is configured to continuously sense a system load of an IT device desired to manage in power/energy, and generate management time information for power/energy management based on a pattern of the sensed load. For example, the load pattern analyzer may generate a time interval required to be managed in power/energy as management time information by continuously sensing a system load of an IT device during a predetermined period of time, and analyzing a pattern of the system load on the basis of a day, a date, or a time period. The management time information generated as such may be assigned a priority order.

In step S200, the time information analysis unit 120 of the power/energy management apparatus 100 registers a management action event for power/energy management by analyzing management time information.

For example, the time information analysis unit 120 extracts and arranges information about a time at which a management action event for power/energy management occurs, by analyzing the management time information received through the time information acquiring unit 110. In addition, the time information analysis unit 120 registers a timer event (a management action event) by communicating with a timer module 150 such that a power/energy management action is performed. For example, the time information analysis unit 120 may be a time information analyzing module implemented on an operating system kernel.

The time information analysis unit 120 is provided in an operating system kernel of an IT device system desired to manage in power/energy (for example, /sys file system of linux system). If the time information acquiring unit 110 is not provided in an operating system kernel, the time information analysis unit 120 may acquire management time information by using a kernel/user interface connecting the time information acquiring unit 110 to the time information analysis unit 120. In addition, the time information analysis unit 120 registers a management action event by communicating with the timer module 150 implemented in the operating system kernel.

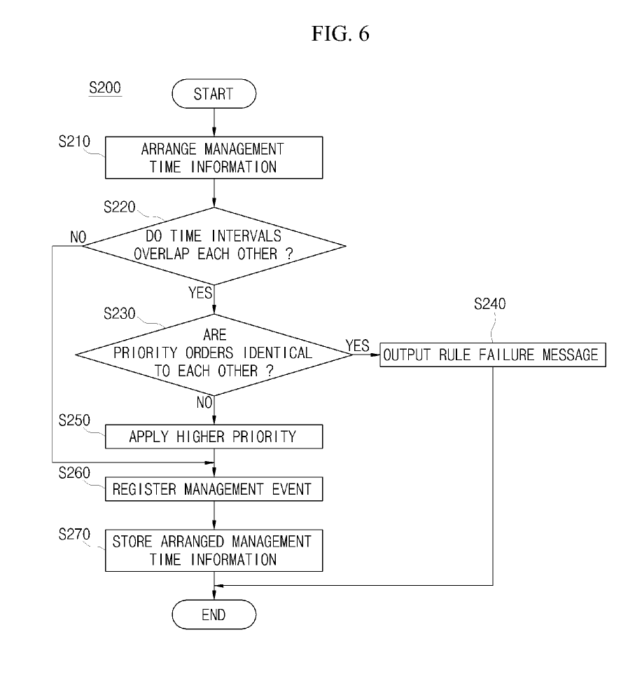

Hereinafter, a detailed operation (S200) of the time information analysis unit 120 will be described with reference to FIG. 6.

In step S210, the time information analysis unit 120 arranges management time information.

The time information analysis unit 120, if it is sensed that management time information is added, changed, or deleted, arranges the management time information. That is, if management time information is updated as a user input is received through the time information acquiring unit 110, the time information analysis unit 120 arranges the management time information. For example, if new management time information is received through the time information acquiring unit 110, the time information analysis unit 120 arranges a plurality of pieces of management time information previously stored in the storage unit 140 together with the newly received management time information. In this case, the time information analysis unit 120 arranges the plurality of pieces of management time information in the ascending order of the start time value or end time value.

In step S220, the time information analysis unit 120 checks whether the plurality of pieces of management time information overlap each other.

The time information analysis unit 120 checks whether there is management time information whose time interval overlaps among the plurality of pieces of management time information by using the start time value and the end time value.

For example, the time information analysis unit 120 checks whether an interval between a start time and an end time recognized by a start time value and an end time value included in newly received management time information overlaps an interval between a start time and an end time of the previously stored management time information.

If it is checked as a result of operation S220 that the time intervals overlapping each other exist, in step S230, the time information analysis unit 120 checks a priority of each management time information.

The time information analysis unit 120 checks a priority order of management time information whose time interval overlaps time interval of another management time information. In this case, the time information analysis unit 120 checks priorities of at least two pieces of management time information whose time intervals overlap each other, and determines whether the priorities are identical each other.

If it is determined as a result of operation S230 that the priorities are identical to each other, In step S240, the time information analysis unit 120 outputs a rule failure message.

If the priorities are identical to each other, the time information analysis unit 120 is not able to determine management time information based on which a power/management action is to be performed during the overlapping time interval. Accordingly, operation S240 is performed to output a rule failure message to notify a user that the time information analysis unit 120 is not able to determine management time information.

If it is determined as a result of operation S230 that the priorities are different from each other, in step S250, the time information analysis unit 120 applies management time information having a higher priority.

The time information analysis unit 120 determines to perform a power/energy management action based on management time information having a higher priority with respect to an overlapping time interval.

Thereafter, in step S260, the time information analysis unit 120 registers a management action event such that a management/energy action is performed.

The time information analysis unit 120 registers a timer event (a start event or an end event) in the timer module 150 such that a management action event for power/energy management is performed at a start time and an end time of the updated management time information. In this case, a start time value of the updated management time information is registered as a start event of the timer module 150 for management action start, and an end time value of the updated management time information is registered as an end event of the timer module 150 for management action end. In addition, with respect to the overlapping time interval, a timer event is registered based on management time information determined to have a higher priority. Depending on situations, for example, when previously stored management time information is deleted, the previously registered timer event is canceled (deleted).

In step S270, the time information analysis unit 120 stores the updated management time information in the storage unit 140.

For example, the time information analysis unit 120 stores a plurality of pieces of management time information, updated according to the order arranged in operation S210, in the storage unit 140 in the form of Table 1.

By performing operations S210 to S270, the time information analysis unit 120 completes the process of analyzing management time information and registering/deleting a timer event for performing a management/energy action.

In step S300, The power management unit 130 checks occurrence of a management action event, and performs a power/energy management action.

The power management unit 130 checks a management action event registered by the time information analysis unit 120, and accesses and controls the control modules 210, 220, and 230 for power/energy management according to a management action event corresponding to the current time, thereby performing a power/energy management action. For example, the power management unit 130 may be a power management execution module implemented in the operating system kernel 200.

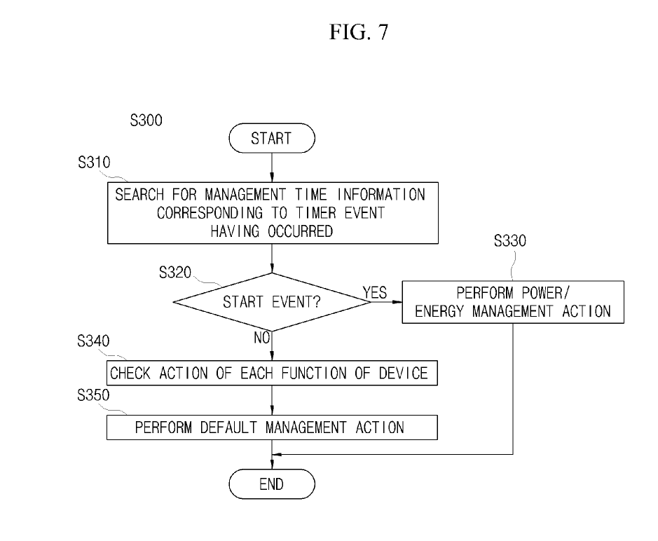

Hereinafter, a detailed operation of the power management unit 130 will be described with reference to FIG. 7.

In step S310, the power management unit 130 searches for management time information corresponding to the timer event in the storage unit 140 if it is sensed that a timer event has occurred.

For example, if a timer event occurs according to an operation of the timer module 150 in the operating system kernel 200, the power management unit 130 scans (searches) the storage unit 140 to acquire management time information corresponding to the current timer event from among a plurality of pieces of previously stored management time information.

In step S320, the power management unit 130 determines whether the timer event is a start event by checking the found management time information.

For example, the power management unit 130 determines whether a timer event having occurred is an event corresponding to a start time or an end time. In this case, the power management unit 130 may determine whether the timer event is a start event or an end event by checking a time at which the timer event has occurred is a start time value of the found management time information or an end time value of the found management time information.

If it is determined as a result of operation S320 that the timer event is a start event, in step S330, the power management unit 130 performs a power/energy management action.

The power management unit 130, if the timer event having occurred is an event corresponding to a start time, enters a power/energy management action, that is, a maximum power saving mode. For example, the power management unit 130 performs a power/energy management action by controlling the plurality of control modules 210, 220, and 230. When the power/energy management action is performed, hardware of the IT device desired to manage in power/energy is controlled through the respective device managers of the plurality control modules 210, 220, and 230, such that the IT device enters a maximum power saving mode, thereby managing power/energy of the IT device. For example, the power management unit 130, when the IT device enters a maximum power saving mode, stores a final usage status of the system as a snap shot in a storage, and shuts off power, thereby maximizing the power saving effect.

If it is determined as a result of operation S320 that the timer event is not a start event, in step S340, the power management unit 130 checks an action of each function of the IT device for default management.

For example, the power management unit 130, if the timer event having occurred is not an event corresponding to a start time but an event corresponding to an end time, performs a default management on the IT device. That is, power/energy of the IT device is managed by default during a period of time between an end time of the management time information having been executed and a start time of management time information that is to be executed next.

For the default management, the power management unit 130 periodically checks an action of each function of the IT device. For example, the power management unit 130 checks an action of a function corresponding to default management time information. The power management unit 130 determines whether a condition for a default management action is satisfied by checking an action of each function of the IT device.

For example, when assumed that default management time information of the storage unit 140 previously stores a rule allowing the IT device to enter a power saving mode if no user input is sensed for 10 minutes, the power management unit 130 determines whether a user input is sensed for 10 minutes by checking actions for respective functions of the IT device.

In step S350, the power management unit 130 performs a default management action according to the result of the checking in operation S340. The power management unit 130 performs a default management action by controlling the plurality of control modules 210, 220, and 230 if the action for each function of the IT device satisfies the condition for performing a default action.

For example, it may be assumed that a rule allowing the IT device to enter a power saving mode if no user input is sensed for 10 minutes is stored in default management time information of the storage unit 140. If a user input to the IT device is not sensed for 10 minutes, the power management unit 130 performs a default management action (entering a power saving mode). That is, the power management unit 130 performs a default management action by controlling hardware of the IT device desired to manage in power/energy through the device managers 211, 212, 221, 222, 231, and 232 of the plurality of control modules 210, 220, and 230.

Through these actions, the power/energy management apparatus 100 performs power/energy management on an IT device based on time information. In addition, the power/energy management apparatus 100 may edit and enforce a power management policy in terms of collective functions through a rule definition in the form of a table, thereby promoting a convenience in the power and energy management. A user may easily define an action of the time period-specific power management by adding, editing, and deleting a table rule (an entry). In addition, a table may be automatically generated through an additional load analyzer, and linked.

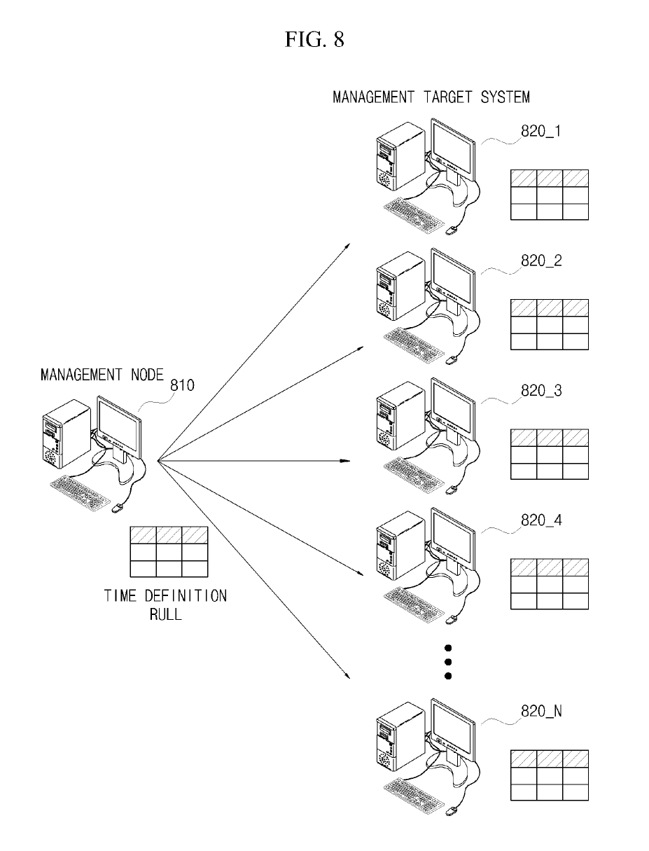

Moreover, the power/energy management apparatus 100 may be centrally managed as shown in FIG. 8. For example, in a site of computer education or in an office, a manager (a management node) 810 transmits a time definition rule (management time information and default management time information) defining time information to management target devices (computers) 820_1 to 820_N through a network, and the same time definition rule is applied to systems of all the management target devices 820_1 to 820_N, so that unified and convenient power management is performed on all the management target devices 820_1 to 820_N.

In addition, the power/energy management apparatus 100 may enhance the power efficiency if system on/off phases are distinctive, which is a representative case proving the efficiency of the power/energy management function based on time information. For example, when a computer is used only for 8 hours of 24 hours in a general office environment in which a 7/24 operation system is not applied, the power/energy management apparatus 100 does not force the power saving mode during a working time, and forces a power saving mode during the remaining time, thereby enhancing the power efficiency.

As is apparent from the above, the system of the IT device is forced to operate at a power saving mode during a predetermined period of time, and during the remaining period of time, the power saving mode is not forced, so that the system stability and power saving effect can be provided. In addition, during a predetermined time period, the whole computer operates at a maximum power saving mode, that is, the power is shut off while storing the final usage status of the system as a snap shot in a storage unit, thereby maximizing power saving effect.

In addition, the present invention provides a comprehensive power saving function of a system level, so power saving is not considered for each device. In addition, a management time rule of a user level is defined, so that a time period of policy enforcement is easily designated, and if only a user inputs time information, the remaining process is automatically controlled at a system level (an operating system level).

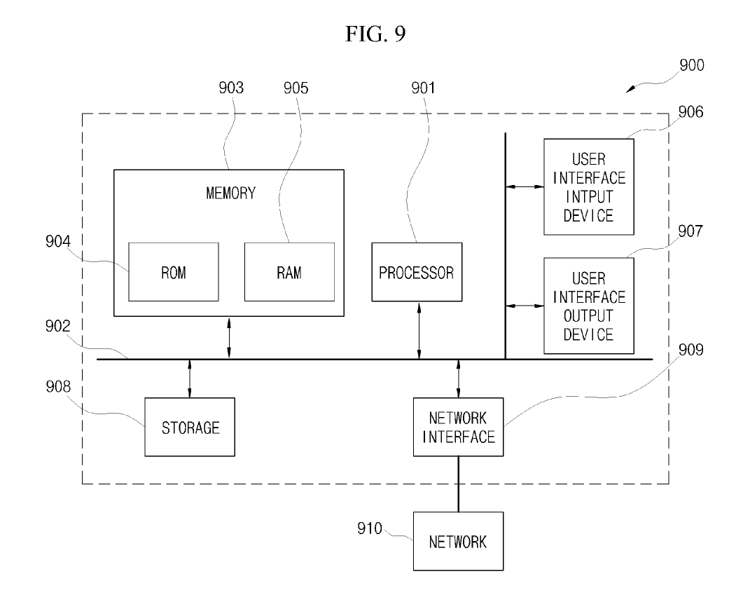

An embodiment of the present invention may be implemented in a computer system, e.g., as a computer readable medium. As shown in FIG. 9, a computer system 900 may include one or more of a processor 901, a memory 903, a user input device 906, a user output device 907, and a storage 908, each of which communicates through a bus 902. The computer system 900 may also include a network interface 909 that is coupled to a network 910. The processor 901 may be a central processing unit (CPU) or a semiconductor device that executes processing instructions stored in the memory 903 and/or the storage 908. The memory 903 and the storage 908 may include various forms of volatile or non-volatile storage media. For example, the memory may include a read-only memory (ROM) 904 and a random access memory (RAM) 905.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An apparatus for managing power/energy based on time information of policy enforcement, the apparatus comprising:
a time information acquiring unit configured to acquire management time information including a start time value, an end time value, a day repetition value, and a date repetition value of a power/energy management action with respect to a management target device desired to manage in power/energy;
a time information analysis unit configured to analyze the management time information acquired by the time information acquiring unit and to register a management action event for power/energy management in a timer module; and
a power management unit configured to perform an power/energy management action on the management target device by checking occurrence of the management action event and controlling operations of control modules of the management target device.

2. The apparatus of claim 1, wherein the time information acquiring unit further acquires a priority value of the management time information.

3. The apparatus of claim 2, further comprising a storage unit configured to store a plurality of pieces of management time information acquired by the time information acquiring unit,
wherein the storage unit arranges the plurality of pieces of management time information based on at least one of the start time value, the end time value, and the priority value.

4. The apparatus of claim 3, wherein the storage unit further stores default management time information applied to a time interval that is not included in the management time information.

5. The apparatus of claim 1, wherein the time information analysis unit registers the management action event including a start event and an end event in consideration of the start time value and the end time value of the management time information.

6. The apparatus of claim 5, wherein the time information analysis unit checks whether a time interval between the start time value and the end time value of the management time information received through the time information acquiring unit overlaps a time interval between a start time value and an end time value of another management time information that is previously stored, and if it is checked that the time intervals overlap each other, registers the management action event by using management time information having a higher priority between the two pieces of management time information whose time intervals overlap each other.

7. The apparatus of claim 5, wherein the power management unit, if the management action event having occurred is the start event, converts the management target device into a maximum power saving mode, and performs the power/energy management action on the management target device.

8. The apparatus of claim 5, wherein the power management unit, if the management action event having occurred is the end event, manages the management target device by applying default management time information that defines rule information that is to be applied by default to a time interval for which no rule is defined in the management time information.

9. The apparatus of claim 8, wherein the power management unit, when managing the management target device by applying the default management time information, checks an action for each function of the management target device, and if the action for each function satisfies a predetermined default action condition, performs a default management action.

10. The apparatus of claim 1, wherein the time information acquiring unit further acquires management time information from a load pattern analyzer that is configured to continuously sense a system load of the management target device and to generate the management time information based on a pattern of the sensed load.

11. A method of managing power/energy based on time information of policy enforcement, the method comprising:
acquiring management time information including at least one of a start time value, an end time value, a day repetition value, a date repetition value, and a priority value of a power/energy management action with respect to a management target device;
extracting information about a time at which a power/energy management action event with respect to the management target device occurs, by analyzing the management time information;
registering a management action event including a start event and an end event of the power/energy management action by using the extracted time information; and
performing a power/energy management action on the management target device by checking occurrence of the management action event.

12. The method of claim 11, wherein in the registering of the management action event, it is checked whether a time interval between the start time value and the end time value of the acquired management time information overlaps a time interval between a start time value and an end time value of another management time information previously stored, and if it is checked that the time intervals overlap each other, the management action event is registered by using management time information having a higher priority between the two pieces of management time information whose time intervals overlap each other.

13. The method of claim 11, wherein in the performing of the power/energy management action, the management target device, if the management action event having occurred is the start event, is converted into a maximum power saving mode such that the power/energy management action is performed on the management target device, and the management target device, if the management action event having occurred is the end event, is managed by applying default management time information defining rule information that is to be applied by default to a time interval having no rule defined in the management time information.

14. The method of claim 13, wherein in the performing of the power/energy management action, when managing the management target device by applying the default management time information, an action for each function of the management target device is checked, and if the action for each function satisfies a predetermined default action condition, a default management action is performed.

15. The method of claim 11, wherein in the acquiring of the management time information, management time information is further acquired from a load pattern analyzer that is configured to continuously sense a system load of the management target device and generate the management time information based on a pattern of the sensed load.
